(19) United States
(12) Patent Application Publication
(10) Pub. No.: US 2025/0298418 A1
(43) Pub. Date: Sep. 25, 2025

(54) PICK PATH ROUTE OPTIMIZATION

(71) Applicant: BJ’s Wholesale Club, Inc., Marlborough, MA (US)

(72) Inventors: Saranath RANGAMANNAR, Shrewsbury, MA (US); Sanjay PRABHU, Hopkinton, MA (US); Chelsea PAULHUS, Cranston, RI (US); Saad SYED, Westborough, MA (US); Emily CAHOON, Franklin, MA (US); Georges BILAN, Blackstone, MA (US); Ezhilarasan VAITHYANATHAN, Philadelphia, PA (US); Edward HISER, JR., Bridgevile, PA (US); Praneeth Kothapalli SEKHAR, Holden, MA (US); Anirudh BHARGAVA, Northborough, MA (US); Fatema JANNAT, Brooklyn, NY (US)

(73) Assignee: BJ’s Wholesale Club, Inc., Marlborough, MA (US)

(21) Appl. No.: 18/613,068

(22) Filed: Mar. 21, 2024

(51) Int. Cl. G05D 1/644; B65G 1/137; G05D 105/20; G05D 107/70; G05D 111/10; G06Q 10/087

(52) U.S. Cl. CPC G05D 1/644; B65G 1/1373; G06Q 10/087; B65G 2203/044; G05D 2105/20; G05D 2107/70; G05D 2111/10

(57) ABSTRACT

Method and system and computer product for picking orders disposed at a plurality of locations in an establishment. A method includes constructing a table of distance values between the plurality of locations; associating a plurality of inventory products with the plurality of locations of the table; and applying an optimization algorithm to the table to determine a shortest path for picking an order.

### FIELD OF THE DISCLOSURE

The present disclosure relates generally to product locating services and, more particularly, to using product locating services to optimize pathing and routing within establishments.

### BACKGROUND OF THE DISCLOSURE

When customers submit orders to retail establishments, the establishments employ team members to fulfill these orders, singularly or in batches of orders, from storage sites of the establishment, such as warehouses or “clubs.” The team members, or pickers, retrieve the individual items from around the club to be packaged for pickup or shipping to the ordering customer. It is a costly and time-consuming process that may require the team members to cover large distances across the club in inefficient routes. Compounding the issue, oftentimes items are out of stock or misplaced, wasting time and effort for team members to go out of their way, double-back, or waste an entire trip.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for picking orders disposed at a plurality of locations in an establishment is provided. The method includes constructing a table of distance values between a plurality of locations, associating a plurality of inventory products with the plurality of locations in the table, and applying an optimization algorithm to thereby determine a shortest path for picking an order.

In another embodiment, a system for picking orders disposed at a plurality of locations in an establishment is provided. The system includes a processor and memory, configured to construct a table of distance values between a plurality of locations, associating a plurality of inventory products with the plurality of locations in the table, and applying an optimization algorithm to thereby determine a shortest path for picking an order.

In another implementation, a machine-readable storage medium having stored thereon a computer program for picking orders disposed at a plurality of locations in an establishment is provided. The computer program includes a routine of set instructions for causing the machine to perform the steps of: constructing a table of distance values between a plurality of locations, associating a plurality of inventory products with the plurality of locations in the table, and applying an optimization algorithm to thereby determine a shortest path for picking an order.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram depicting an example portion of a floorplan of a storage facility of an establishment.

FIG. 2 is a diagram depicting an example of a table of distance values.

FIG. 3 is a block diagram of a system for path optimization for order fulfillment in a storage facility.

FIG. 4 is a flow diagram depicting an example method for picking orders disposed at a plurality of locations in a storage facility.

FIG. 5 is a flow diagram depicting an example method for associating a plurality of inventory products with a plurality of locations.

FIG. 6 is a block diagram depicting an example of a computer system for path optimization for order fulfillment in a storage facility.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to product locating services and, more particularly, to using product locating services to optimize pathing and routing within establishments.

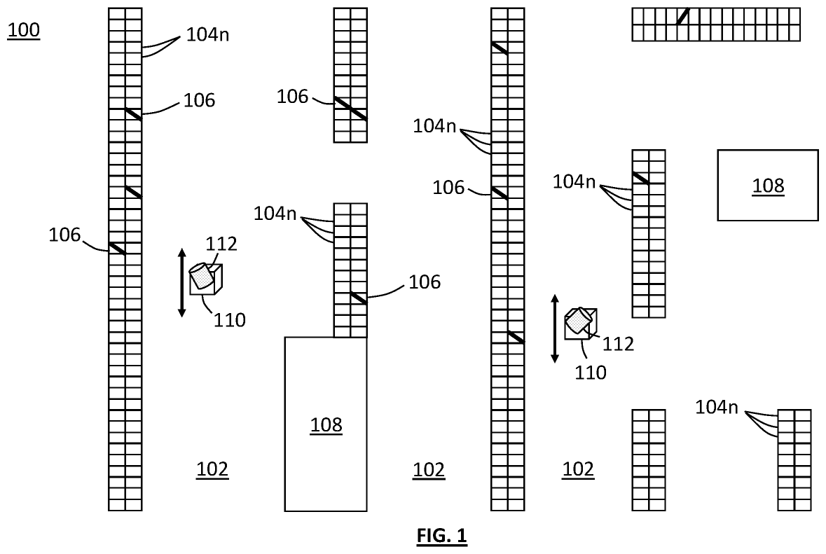

FIG. 1 is a diagram depicting an example portion of a floorplan of a storage facility 100 of an establishment. The storage facility 100 may be referred to herein as a warehouse or club, and may be a strictly wholesale facility for product storage only, or it may be open to customers and operate as a retail facility as well. The storage facility 100 includes a plurality of aisles 102 having multiple product storage locations 104, such as shelves or the like, that may be vertically stacked. Some of these locations, denoted 106, may be empty and awaiting re-fill, or are simply unusable, or are used for various other purposes such as backup storage or temporary storage. The facility 100 may also include one or more landmarks 108, which may or may not also provide storage—for example a cold walk-in compartment for dairy and/or fresh produce, or a baked goods section, or similar storage category. Landmarks 108 can also be any noteworthy or consistent location that can be used as a reference point. For example, landmark locations can include, but are not limited to, a frozen food section, a lumber section, an aisle where forklifts or various other equipment is stored, or an administrator's office.

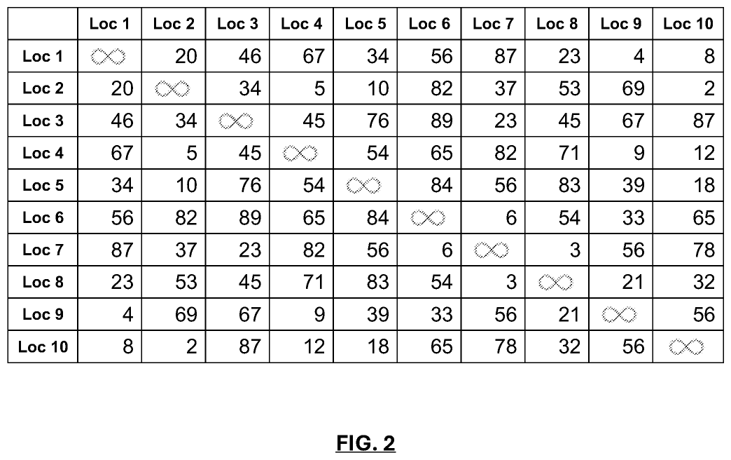

It will be appreciated that given a predetermined number N of storage locations 104 of the facility 100, each individual storage location 104n, where n is an integer between 1 and N, is some fixed distance from every other individual storage location 104n, taking the most efficient path between the two locations, including around any obstacles (such as aisles, landmarks 108, etc.) for instance for example using A-star algorithm. The totality of these fixed distances between all the storage locations of the facility 100 can be represented in an N×N storage location table or matrix 200, shown in FIG. 2. For simplicity, only an example set of ten storage locations (N=10) are treated, with all the combinations of distances between these ten locations shown, but it will understood that any number of storage location distances can be so represented.

In certain embodiments, all N storage locations 104 can be stored and/or represented as coordinates. All combinations of distances between these coordinates can be calculated for storage within the table 200. These distance values can be obtained by manual measurement, or by calculation based on the floorplan, taking any obstacles into account, or by similar means. For example, if a floorplan exists with a scale ratio, then any distance value between any coordinates can be measured by hand, using a ruler and the scale ratio; or the distance value can be measured electronically, using a program, or by a robot traversing the storage facility 100 and making automated measurements through optical means or the like. For example, as depicted in table 200, a distance between Location 2 and Location 6 can be measured on a computer using the floorplan to be 56 meters. This value of 56 meters is then stored in the table 200. All combinations of all locations' distances between each other can be stored similarly, and thus making up the contents of the table 200 of distance values.

Storage facility 100 can also include automated inventory sensing devices to determine which locations 104 are occupied by products, and which are not occupied (denoted at 106), and to identify the products detected at the locations. With reference again to FIG. 1, such inventory sensing devices 110 can take the form of robots equipped with optical scanners 112 and supporting hardware and/or software (not shown), that are operable to scan storage locations 104 to determine if they are occupied by inventory products or empty, and to recognize the nature of the contents—that is, which products—are present therein. The robots may be configured to reciprocate in dedicated aisles 102, as indicated by the double-headed arrows, on fixed tracks on the floor or ceiling (not shown); or they may be unfixed and movable from aisle to aisle on wheels or treads (not shown). In certain embodiments, they may be equipped with swiveling scanner mounts (not shown) to enable the scanners 112 to maintain line-of-sight with the storage locations 104 as the robots move. Alternatively or in addition, some or all of the robots 110 can be dispensed with, and fixed scanners can be mounted at various locations, for example in the ceiling between aisles, to scan the locations 104 to determine full/empty status, and identify products therein, with a sufficient number of scanners to cover a requisite number of storage locations 104. Each aisle or bay or landmark may also be equipped with location tags to be scanned which likewise provide the above information. These location tags may include any form of readable technology, such as for example a QR code. In certain embodiments, the robots and scanners may also be operable to determine the number of items per storage location 104, and not simply whether the location is full or empty. In certain embodiments, non-optical means—for example ultrasonic—may be employed by the scanners 112, in addition to or in lieu of the optical means, to sense the full/empty status of the storage locations 104. In certain embodiments, certain locations 104 may be dedicated to certain products, and it may therefore not be necessary for the inventory sensing devices 110 to identify the products as these are already known. In such a situation, the task of the inventory sensing device 110 can be reduced to merely determining whether the dedicated location 104 is occupied or devoid of product, and possibly how many products. Conversely, in certain embodiments, the products themselves are scanned, and these are encoded with information from which their location can be inferred if it is known for example that certain products or categories of products are always stored at certain locations (e.g., meats in refrigerated meat section, ice cream in frozen section, etc.). In such a situation, the products themselves are known to the system as products that are normally stored in known dedicated locations, so that their mere scanning by the sensing devices 110 permits an inference of their location. In this latter situation, it will be appreciated, the sensing devices 110 are configured to scan the products themselves, or tags such as UPC bar or QR codes thereon, rather than, or in addition to, scanning the storage locations 104. The bar or QR codes can encode other information, such as product category, department, date and place of origin or packaging, and so on. Knowing product category and/or department—for example dairy or baked goods or fresh produce—can provide an additional inference of where it is stored, such as in a landmark location 108 mentioned above.

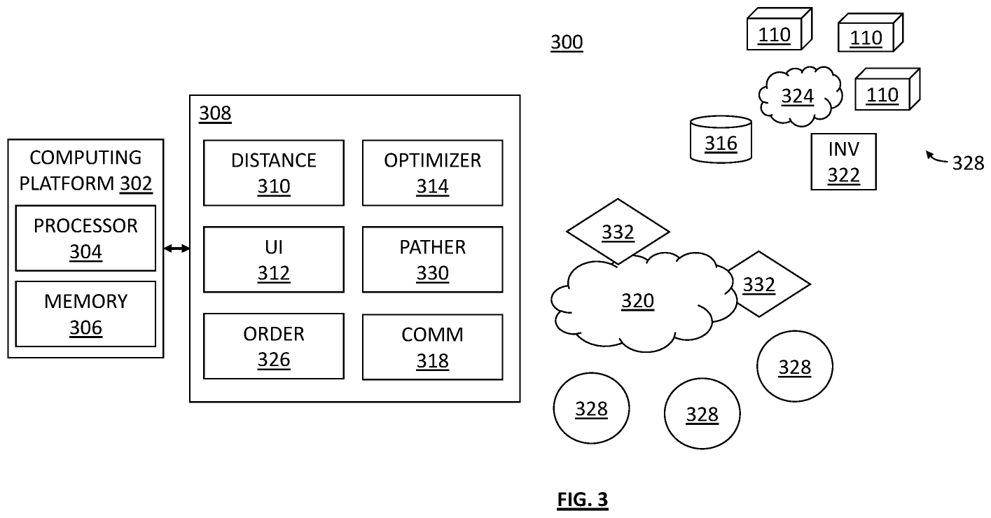

FIG. 3 is a block diagram of a system 300 for path optimization for order fulfilment in a storage facility in accordance with certain embodiments. In some examples, one or more aspects of the system 300 can be implemented (e.g., as machine readable instructions) on a computing platform 302. The computing platform 302 can include one or more computing devices selected from, for example, a desktop computer, a server, a controller, a blade, a mobile phone, a tablet, a laptop, a personal digital assistant (PDA), and the like. The computing platform 302 can include a processor 304 and a memory 306. By way of example, the memory 306 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 304 can be implemented, for example, as one or more processor cores.

The memory 306 can store machine-readable instructions that can be retrieved and executed by the processor 304. Each of the processor 304 and the memory 306 can be implemented on a similar or a different computing platform. The computing platform 302 can be implemented in a cloud computing environment (for example, as disclosed herein) and thus on a cloud infrastructure. In such a situation, features of the computing platform 302 can be representative of a single instance of hardware or multiple instances of hardware executing across the multiple of instances (e.g., distributed) of hardware (e.g., computers, routers, memory, processors, or a combination thereof). Alternatively, the computing platform 106 can be implemented on a single dedicated server or workstation.

System 300 includes a path optimization platform 308 having a distance calculating module 310 that is operable to receive information relating to the floorplan or layout of a storage facility, such as facility 100 (FIG. 1), which may be a club or warehouse, and to calculate therefrom the distances between the storage locations 104. An output of distance calculating module 310 may be table 200 (FIG. 2) discussed above. In certain embodiments, the information of table 200 may be provided a priori to the optimization platform 308 through a user interface 312, which may include a keyboard, scanner, personal digital assistant (PDA), or the like, and calculation of the distances using distance calculating module 310 may not be necessary. In certain embodiments, only updates to the distances and table 200 may be necessary, for example using user interface 312, such as when the floorplan of the storage facility 100 has been rearranged or changed to some degree and certain distances between locations 104 may have changed.

Optimization platform 308 also includes an optimizer module 314 that is operatively coupled to an inventory location database 316, by way of a communication module 318 and a network 320, which may include one or more wired or wireless intranets, the Internet, or a combination thereof. Inventory location database 316 contains information correlating the contents of storage locations 104 with inventory products, as determined by robots 110 in the manner described above. The robots 110, together with an inventorying platform 322 and database 316, linked together by a network 324, form an inventory service 328 that provides up-to-date status and content information relating to the locations 104 of storage facility 100 and the inventory contents thereof, including which locations 104 are occupied, and by which products, and optionally, how many products, and so on, as described above. The status and content information is gleaned from scanning the locations 104 and/or the products themselves (e.g. UPC codes thereof) as described above, and is stored and updated in database 316, and can be pushed to or pulled by optimizer 314 of optimization platform 308. As mentioned above, in certain embodiments, the scanned products, by virtue of their identity as recognized by the sensing devices 110, provide an inference of their particular storage location 104 as some locations may be dedicated to storage of the product. In certain embodiments, inventorying platform 322 can determine product inventory status and convey that information to users, for example via optimization platform 308 and communication module 318, to notify users that certain products may be low or out of stock and need to be replenished.

Optimizer 314 is configured to apply an optimization algorithm that determines the shortest and/or most efficient route necessary to fulfil an order or batch of orders, sorting the products of the order, or batch of orders, in the proper picking sequence in conformance with that route. The orders may be acquired and/or compiled by ordering module 326, being for instance entered through UI 312; or they may be “online” orders submitted through a service (not shown) or individual customer devices 328 (e.g. mobile phones, tablets, desktop browsers, store kiosks, etc.) that are coupled to platform 308 via network 320. The orders are then assigned to pickers, who are individuals employed to fulfil them, singularly or in batches, by traveling to the various locations 104 in the storage facility 100, in the most optimal route and sorted order determined by the optimization platform, and more specifically, the optimizer 314. In certain embodiments, the optimization algorithm applied by optimizer 314 can be approached as the “traveling salesman” problem, whereby the shortest route between different points—locations 104 in storage facility 100 that contain products corresponding to the online order or batch of orders in this instance—is determined. Various options, such as a brute force method or nearest neighbor method, may be employed by the algorithm, to determine the shortest path, taking any obstacles such as aisles, landmarks, etc. into account, and also accounting for, and omitting from the path, any out of stock items. The output of optimizer 314, which is the shortest route to fulfil an order or batch of orders, as well as the picking order, and which may include alternate routes, is delivered to pather 330 which can compile these routes and deliver them to devices 332 that the pickers can carry and use for guidance through the storage facility 100. The routes can be displayed as maps or lists or directions for the pickers to follow, on their devices 332 or on signs or other guidance expedients in the facility 100, and/or can take the form of audible directions so presented, or any combination of these. In certain embodiments, the optimizer 314 can dynamically recalculate the path if a member wants to manually change the order of picking or start from different locations or override the recommendations based on inventory locations.

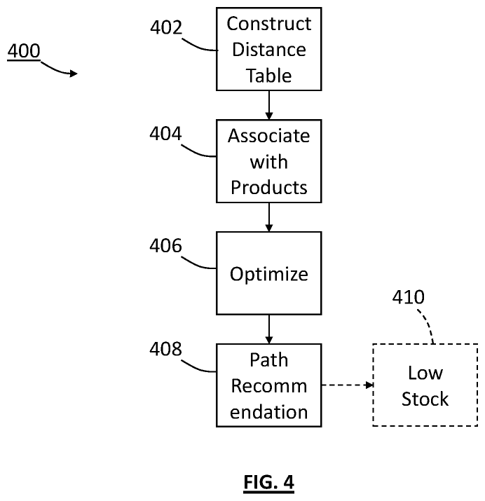

FIG. 4 is a flow diagram of an example method 400 for picking orders disposed at a plurality of locations 104 in a storage facility 100 in accordance with certain embodiments. At step 402, a table of distance values between a plurality of locations is constructed as explained above. In step 404, the plurality of locations in the table can be associated with a plurality of inventory products.

The coordinates in a table represent a location, and these locations can correspond to inventory items that are at those locations. The products and locations can pertain to departments or categories. For example, all the household cleaning supply products can be stored in a particular set of aisles. The organization of these locations can be determined by any means, including but not limited to convenience, relationship between products, alphabetically, or by proximity to exits or other landmarks. For example, the location of lumber products can be near a loading dock for ease of entry and distribution. These locations can be tracked by any means, such as a simple ledger or inventory sheet, or, as explained above, and robots 110 can travel around a warehouse and take images of products and/or locations 104, or read barcodes of products to compile an inventory of the products and their locations. The robots may then store this data as a dynamic updatable database (316, FIG. 3) that is then accessed by the system as needed. An alternative example can include a smart-shelving system. An example of a smart-shelving system may include placing sensors at locations that detect, optically for example, the presence of items and then sends that information to the database. In another embodiment, these sensors could be mounted to the ceiling and rotate above the aisles, having lines of sight to multiple locations to detect the presence of items.

In step 406, an optimization algorithm is applied to the table to thereby determine a shortest path for picking an order, said picking comprising traveling to multiple locations of the plurality of locations.

For example, four items are selected via at least one customer order, the four items being located at Locations 1, 2, 6, and 9, respectively. The distances between each of these locations being stored in database table that contains the N×N data for all items, including the four example items as discussed above, are then run through an optimization algorithm, calculating all the possible combinations of pathing between them, and determining a path with the smallest distance total. A picker can then traverse this shortest path to retrieve each item in the most efficient and time-saving way.

An optimization algorithm may be any algorithm that calculates and prioritizes efficiency in any nontrivial metric, including but not limited to distance, time, or number of items. For example, the traveling salesman problem is a benchmark for optimization methods commonly used in fields such as mathematics and computer sciences. The traveling salesman problem seeks to ascertain the shortest possible path connecting any number of points, while returning to the beginning, or: given a list of cities and the distances between each pair of cities, what is the shortest possible route that visits each city exactly once and returns to the origin city? In certain embodiments, the optimization algorithm will apply as one of its input constraints the type of order to be picked, as several types of orders are contemplated. These types of orders may be treated differently and the optimal path may be different depending on which type of order is entered. Among these are Ship From Club (SFC) orders, Buy Online and Pickup in Club (BOPIC) orders, and Same Day Delivery (SDD) orders. Picking and staging locations for SFC may be different than BOPIC or SDD for example, and thus dynamic treatment and pathing may be implemented to accommodate the variable start and end locations for the different order types.

At 408, a recommended picking path (or optionally, multiple paths) is presented to pickers of the storage facility, for example through email or SMS or an app that is sent to their user devices 332. Optionally, at 410, an indication of low or out of stock inventory is sent. In certain embodiments, APIs may be used to retrieve and refresh location data and inventory availability data from the robot database.

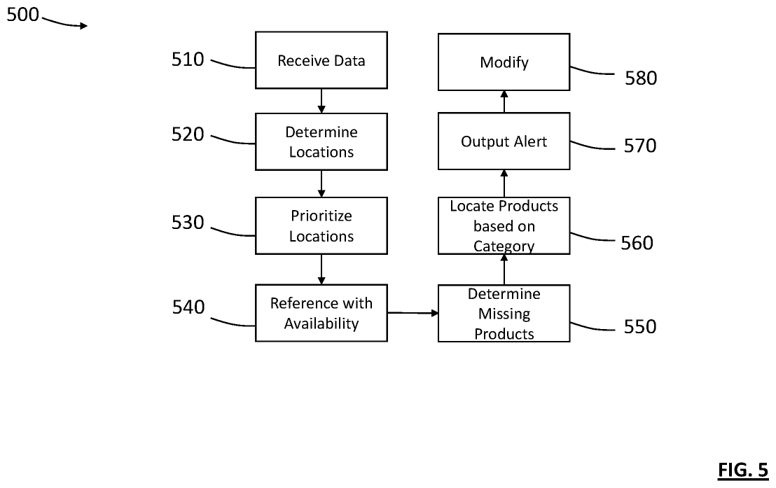

In another embodiment, as depicted in flowchart FIG. 5, method 500 for associating a plurality of inventory products with the plurality of locations of the table may also include: receiving batch product data at step 510; determining the plurality of locations of the plurality of products at step 520; prioritizing the products based on a set of latest scanned locations, creating a priority of locations at step 530; referencing the priority of locations with an availability of inventory products at step 540; determining a set of missing inventory products at step 550; locating products based on a product category or a product department at step 560; outputting an alert to an establishment administrator to fix in case of low or no inventory at step 570; and modifying the batch product data and the availability of inventory products to reflect only available inventory products at step 580.

Batch product data may include any form of information concerning an incoming order for fulfillment. For example, five (or any number of) customer orders can be submitted to a warehouse for fulfillment. These orders contain items and the various potential storage locations throughout the warehouse. The list of these items is then checked against the availability of products information acquired by the inventory robots that operate within that warehouse. The items that are missing are removed from the pool of table locations for which the algorithm would then calculate the shortest path through, and a modified shortest path is available to the pickers, absent the missing items, and thus saving the pickers time. Further, the missing items would send a flag or alert to the appropriate authority, such as a facility administrator to fix. Fixing may include, but is not limited to, sending an alert to the customer that the product is out of stock, alerting an inventory team that the product is low or out of stock and in need of replenishment, or recommending alternative products from the same product family, such as dish soap from a different brand, or potting soil if the requested product was gardening soil.

While, for purposes of simplicity of explanation, the example methods of FIGS. 4-5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

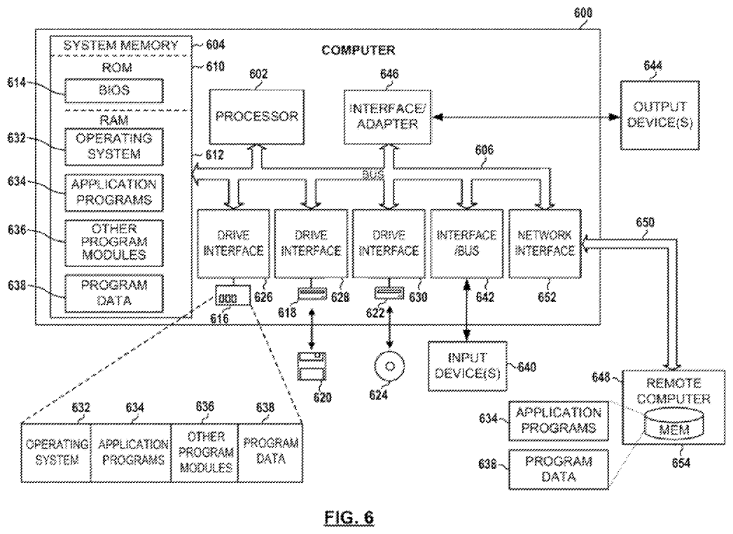

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. System memory 604 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 610 containing the basic routines that help to transfer information among elements within computer system 600.

Computer system 600 can include a hard disk drive 616, magnetic disk drive 618, e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 610, including operating system 632, one or more application programs 634, other program modules 636, and program data 638. In some examples, the application programs 634 can include distance calculating module 310, optimizer module 314, ordering module 326, and communication module 318, and the program data 638 can include table 200. The application programs 634 and program data 638 can include functions and methods programmed to pick orders disposed at a plurality of locations 104 in a storage facility 100, such as shown and described herein.

A user may enter commands and information into computer system 600 through one or more input devices 640, such as a pointing device (e.g., a mouse, touch screen), keyboard, microphone, joystick, game pad, scanner, and the like, and which may correspond to UI 312. For instance, the user can employ input device 640 to edit or modify location table 200. These and other input devices 640 are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for picking orders disposed at a plurality of locations in a storage facility, the method comprising:
constructing a table of distance values between the plurality of locations;
associating a plurality of inventory products with the plurality of locations of the table; and
applying an optimization algorithm to the table to thereby determine a shortest path for picking an order, said picking comprising traveling to multiple locations of the plurality of locations.

2. The method of claim 1, wherein associating a plurality of inventory products with the plurality of locations of the table comprises:
scanning the plurality of locations to determine the presence of inventory thereat.

3. The method of claim 2, wherein the scanning is conducted by moving robots.

4. The method of claim 3, wherein the locator service uses APIs to retrieve and refresh location data and inventory availability data from a robot database.

5. The method of claim 1, wherein constructing a table of distance values between a plurality of locations further comprises:
receiving, over a computer network, a set of coordinates for a plurality of locations;
calculating distance between coordinates to create a table of map data; and
storing the table of map data in a database.

6. The method of claim 1, wherein associating a plurality of inventory products with the plurality of locations of the table further comprises:
receiving batch product data;
determining the plurality of locations of the plurality of products;
prioritizing the products based on a set of latest scanned locations, creating a priority of locations;
referencing the priority of locations with an availability of inventory products;
determining a set of missing inventory products;
locating products based on a product category or a product department;
outputting an alert to a facility administrator to fix; and
modifying the batch product data and the availability of inventory products to reflect only available inventory products.

7. The method of claim 1, wherein the optimization algorithm receives as input a type of order to be picked, wherein the type of order affects the shortest path.

8. The method of claim 1, further comprising creating a pre-sorted batch of orders to be received by the storage facility for picking.

9. A computing system for picking orders disposed at a plurality of locations in a storage facility, including a processor, a memory, and a path optimization platform, the platform comprising:
a distance module for identifying distances between a plurality of product locations and constructing a table of distance values;
an ordering module for receiving an order containing a plurality of products each associated with a product location;
an optimizer for applying an optimization algorithm to the product locations with which the plurality of products of the received order are associated to determine a most efficient route for picking the products of the order; and
a pather for compiling the routes for delivery to at least one picker.

10. A machine-readable storage medium having stored thereon a computer program for picking orders disposed at a plurality of locations in a storage facility, the computer program comprising a routine of set instructions for causing the machine to perform the steps of:
constructing a table of distance values between the plurality of locations;
associating a plurality of inventory products with the plurality of locations of the table; and
applying an optimization algorithm to the table to thereby determine a shortest path for picking an order, said picking comprising traveling to multiple locations of the plurality of locations.

11. The machine-readable storage medium of claim 8, wherein the set of instructions for associating a plurality of inventory products with the plurality of locations of the table comprises:
scanning the plurality of locations to determine the presence of inventory thereat.

12. The machine-readable storage medium of claim 9 wherein the scanning is conducted by moving robots.

13. The machine-readable storage medium of claim 10 wherein the locator service uses APIs to retrieve and refresh location data and inventory availability data from a robot database.

14. The machine-readable storage medium of claim 8, the set of instructions further causing the machine to perform the steps of:
receiving, over a computer network, a set of coordinates for a plurality locations;
calculating a distance between each coordinate to create a table of map data; and
storing the table of map data on a database.

15. The machine-readable storage medium of claim 8, the set of instructions further causing the machine to perform the steps of:
receiving batch product data;
determining the plurality of locations of the plurality of products;
prioritizing the products based on a set of latest scanned locations, creating a priority of locations;
referencing the priority of locations with an availability of inventory products;
determining a set of missing inventory products;
locating products based on a product category or a product department;
outputting an alert to a facility administrator to fix; and
modifying the batch product data and the availability of inventory products to reflect only available inventory products.

16. The machine readable storage medium of claim 8, wherein the optimization algorithm receives as input a type of order to be picked, wherein the type of order affects the shortest path.

17. The machine readable storage medium of claim 8, the set of instructions further causing the machine to perform the steps of creating a pre-sorted batch of orders to be received by the storage facility for picking.
